(19) United States
(12) Patent Application Publication
(10) Pub. No.: US 2015/0082231 A1
(43) Pub. Date: Mar. 19, 2015

(54) METHOD AND TERMINAL FOR DISPLAYING DESKTOP

(71) Applicant: Xiaomi Inc., Beijing (CN)

(72) Inventors: Tian REN, Beijing (CN); Jiankai Zhao, Beijing (CN); Yang Yu, Beijing (CN); Zhonghui Chen, Beijing (CN); Xiaoyin Li, Beijing (CN)

(21) Appl. No.: 14/470,292

(22) Filed: Aug. 27, 2014

Related U.S. Application Data
(63) Continuation of application No. PCT/CN2014/077468, filed on May 14, 2014.

(30) Foreign Application Priority Data
Sep. 13, 2013 (CN) 201310419166.2

(51) Int. Cl. G06F 3/0481

(52) U.S. Cl. CPC G06F 3/04817
USPC 715/778

(57) ABSTRACT

A method for displaying a desktop on a device, includes: acquiring current weather information; acquiring, according to the acquired current weather information, a theme file corresponding to the current weather information from a pre-downloaded theme package, the theme file including at least a desktop background file, and an icon file corresponding to an icon; and rendering the desktop background file and the icon file onto the desktop of the device.

### CROSS-REFERENCE TO RELATED APPLICATIONS

This application is a continuation of International Application No. PCT/CN2014/077468, filed May 14, 2014, which claims priority to Chinese Patent Application No. 201310419166.2, filed Sep. 13, 2013, the entire contents of all of which are incorporated herein by reference.

### TECHNICAL FIELD

The present disclosure generally relates to the field of mobile terminal technology and, more particularly, to a method and a terminal for displaying a desktop.

### BACKGROUND

To meet personalized needs of different users, terminals may provide dynamic images that display special effects as desktops of the terminals. Since a server provides a variety of dynamic images, the users of the terminals can select the desktops e.g., to express their moods and current weather, or to match their personal preferences.

Conventionally, when a dynamic image is used to reflect weather information, the weather information generally needs to be displayed in accordance with the server's push operation. As a result, the weather information may not be updated timely. In addition, since the dynamic image may be covered by a desktop icon, if the icon is located in area displaying key information, a user may not intuitively and quickly know the weather information.

### SUMMARY

According to a first aspect of the present disclosure, there is provided a method for displaying a desktop on a device, comprising: acquiring current weather information; acquiring, according to the acquired current weather information, a theme file corresponding to the current weather information from a pre-downloaded theme package, the theme file including at least a desktop background file, and an icon file corresponding to an icon; and rendering the desktop background file and the icon file onto the desktop of the device.

According to a second aspect of the present disclosure, there is provided a terminal, comprising: a processor; and a memory for storing instructions executable by the processor; wherein the processor is configured to: acquire current weather information; acquire, according to the acquired current weather information, a theme file corresponding to the current weather information from a pre-downloaded theme package, the theme file including at least a desktop background file, and an icon file corresponding to an icon; and render the desktop background file and the icon file onto the desktop of the device.

According to a third aspect of the present disclosure, there is provided a non-transitory storage medium having stored therein instructions that, when executed by a processor of a terminal, cause the terminal to perform a method for displaying a desktop, the method comprising: acquiring current weather information; acquiring, according to the acquired current weather information, a theme file corresponding to the current weather information from a pre-downloaded theme package, the theme file including at least a desktop background file, and an icon file corresponding to an icon; and rendering the desktop background file and the icon file onto the desktop of the device.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are hereby incorporated in and constitute a part of this specification, illustrate embodiments consistent with the invention and, together with the description, serve to explain the principles of the invention.

FIG. 1 is a flowchart of a method for display a desktop, according to an exemplary embodiment.

FIG. 2 is a flowchart of a method for displaying a desktop, according to an exemplary embodiment.

FIG. 3 is a schematic diagram of a desktop displayed on a terminal, according to an exemplary embodiment.

FIG. 4 is a schematic diagram of a desktop displayed on a terminal, according to an exemplary embodiment.

FIG. 5 is a block diagram of a device for display a desktop, according to an exemplary embodiment.

FIG. 6 is a block diagram of a terminal, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of devices and methods consistent with aspects related to the invention as recited in the appended claims.

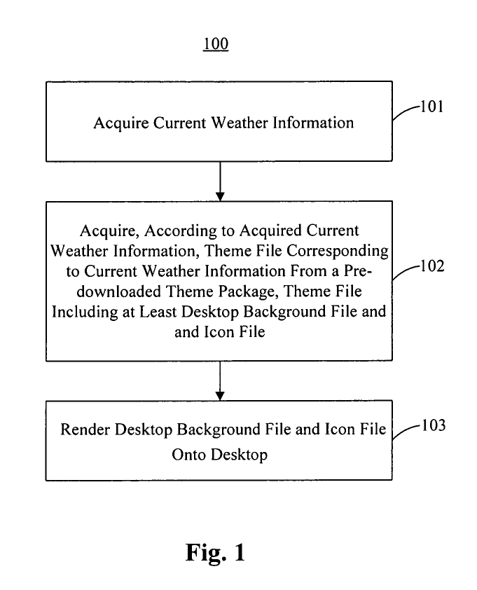

FIG. 1 is a flowchart of a method 100 for displaying a desktop on a terminal, according to an exemplary embodiment. Referring to FIG. 1, the method 100 includes the following steps.

In step 101, the device acquires current weather information.

In step 102, the device acquires, according to the acquired current weather information, a theme file corresponding to the current weather information from a pre-downloaded theme package, the theme file including at least a desktop background file, and an icon file corresponding to an icon.

In step 103, the desktop background file and the icon file are rendered onto the desktop of the terminal.

By using the method 100, a desktop background and the display effect of an icon on the desktop may correspond to the current weather information. Accordingly, a user may intuitively and quickly know the current weather information without viewing detailed text information.

In one exemplary embodiment, the acquiring of the current weather information comprises acquiring, according to a geographical location preset by the terminal, weather information corresponding to the geographical location. In one exemplary embodiment, the acquiring of the current weather information comprises acquiring, according to a geographical location where the terminal is currently located, weather information corresponding to the geographical location.

In one exemplary embodiment, the desktop background file includes a plurality of resources and moving trajectories and display effects of the resources. Accordingly, the rendering of the desktop background file and the icon file onto the desktop comprises rendering the desktop of the terminal in accordance with the plurality of resources and the moving trajectories and the display effects of the resources, such that the resources present the display effects and move according to the moving trajectories on the desktop.

In one exemplary embodiment, the icon file includes an icon file corresponding to an inactive state and an icon file corresponding to an active state. Accordingly, the rendering of the desktop background file and the icon file onto the desktop comprises rendering the icon file corresponding to the inactive state onto the desktop, when the corresponding icon is in an inactive state. Alternatively and/or additionally, the rendering of the desktop background file and the icon file onto the desktop comprises, when an instruction to activate the icon in the inactive icon is detected, withdrawing a rendering effect of the icon file corresponding to the inactive state, rendering the icon file corresponding to the active state onto the desktop, and starting an application corresponding to the icon on the desktop.

In one exemplary embodiment, the icon file further includes an icon file corresponding to a preset operation. Accordingly, the rendering of the desktop background file and the icon file onto the desktop comprises, when the preset operation is detected, withdrawing the rendering effect of the icon file corresponding to the inactive state, and rendering the icon file of the preset operation onto the desktop.

For example, the preset operation can be an operation of shaking, an operation of double-clicking a blank area on a screen, an operation of blowing, etc.

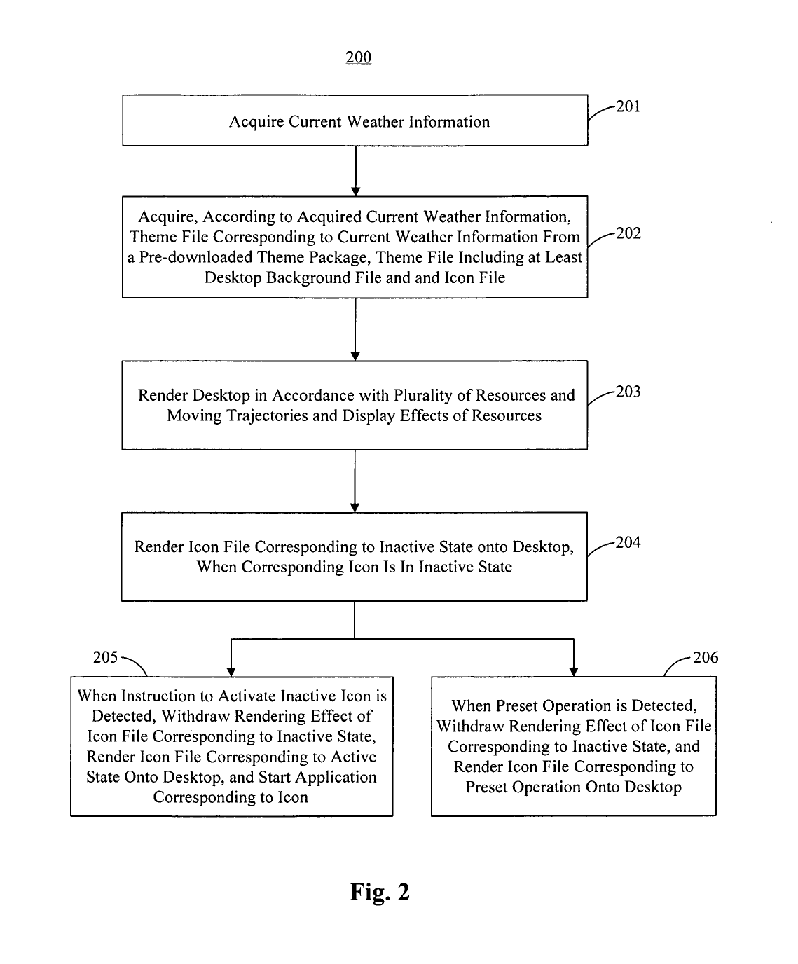

FIG. 2 is a flowchart of a method 200 for displaying a desktop on a terminal, according to an exemplary embodiment. For example, the method 200 can be implemented by the terminal with a desktop launcher that can be implemented with software, hardware, or a combination thereof. The desktop launcher may render a desktop background and a desktop icon according to a theme file for specifying a display effect of the desktop. Referring to FIG. 2, the method 200 includes the following steps.

In step 201, the terminal acquires current weather information.

The weather information includes temperature, humidity, atmospheric particle concentration, night and day, and the like, but it is not limited thereto.

In one exemplary embodiment, the terminal acquires current weather information according to a geographical location where the terminal is currently located. When the terminal is preset for acquiring weather information according to the geographical location where the terminal is currently located, the location where the terminal is currently located may be acquired by ways such as GPS positioning, so as to acquire the weather information according to the geographical location. In one exemplary embodiment, the terminal acquires current weather information according to a geographical location preset by the terminal. In some embodiments, a user of the terminal may also preset a geographical location on the terminal to acquire weather information thereof. The preset geographical location is not necessarily the geographical location where the terminal is currently located, but may be a geographical location of a region of interest to the user of the terminal.

In exemplary embodiments, the weather information may be acquired by a weather server, and the weather server is configured to save a geographical location and the weather information corresponding to the geographical location. For example, the terminal sends an acquiring request to the weather server, the acquiring request including a geographical location determined by the terminal. When the weather server receives the acquiring request, the server sends to the terminal the weather information corresponding to the geographical location in the acquiring request. When the terminal receives the weather information returned by the weather server, the terminal acquires the returned weather information as current weather information corresponding to the geographical location.

In one exemplary embodiment, the terminal periodically acquires current weather information. For example, the terminal acquires current weather information corresponding to the geographical location at every preset period, to achieve the purpose that the current weather information acquired by the terminal is consistent with the actual weather information, thus improving accuracy of the current weather information. A length of the preset period may be preset by technical personnel, or may be adjusted by the user of the terminal, which is not limited in the present embodiment.

In step 202, the terminal acquires, according to the acquired current weather information, a theme file corresponding to the current weather information from a pre-downloaded theme package, the theme file including at least a desktop background file, and an icon file corresponding to an icon.

In the illustrated embodiment, the theme package includes a plurality of theme files corresponding to weather information, and different weather information may correspond to different theme files. The theme package may be pre-downloaded from a server by the terminal and is saved in a file path of the terminal, which is not limited in the present embodiment. In addition, the present embodiment does not limit when the theme package is downloaded.

The theme file includes at least a desktop background file and an icon file. The desktop background file is configured to render a desktop background, and the icon file is configured to render a desktop icon.

The desktop background file may be an extensible markup language (XML) file configured to specify a rendering manner of the desktop background. The desktop background file may also be a graphics interchange format (GIF) file, and the GIF file may be a dynamic image associated with the weather information. The desktop background file may also be a file in another format, which is not limited in the present embodiment.

The icon file may be an XML file configured to specify a rendering manner of an icon. The icon file may also be a GIF file, and the GIF file may be a dynamic image associated with the weather information. The icon file may also be a file in another format, which is not limited in the present embodiment.

In the illustrated embodiment, the desktop background file includes a plurality of resources and moving trajectories and display effects of the resources. In step 203, the terminal renders the desktop in accordance with the plurality of resources and the moving trajectories and the display effects of the resources in the desktop background file, such that the resources present the display effects and move according to the moving trajectories on the desktop.

The resources may include a desktop background picture and elements representing weather, for example, for a rainy day, the corresponding elements may be oblique lines or raindrops that represent raining, and for a snowy day, the corresponding elements may be snowflakes. The elements representing weather may be in various forms such as patterns, texts, icons, etc., which is not limited in the embodiment of the present disclosure.

The moving trajectories of the resources are configured to specify moving trajectories of the elements that represent weather. The moving trajectory corresponding to each element may be different so as to display variable effects. For example, a plurality of raindrops may be rendered in accordance with different moving trajectories. The display effects of the raindrop resources are configured to specify a color. a size, etc. of a raindrop to be displayed. Furthermore, in the desktop background file, position coordinates of an icon on the current desktop may also be specified. If the icon is located on a moving trajectory of a resource, the moving trajectory of the resource is adjusted according to the position coordinates. For example, when a raindrop is covered by an icon on a moving trajectory of the raindrop, the raindrop is transparent on the icon, or the raindrop on the moving trajectory on which the icon is located is made invisible. Also for example, when an raindrop is covered by an icon on a moving trajectory of the raindrop, a first contact point of the moving trajectory and the icon is used as an incident point, a fringe of the icon is used as a mirror surface, and a line perpendicular to the fringe of the icon is used as an axis. The initial moving trajectory is adjusted to a moving trajectory symmetrical relative to the incident trajectory, and the raindrop is rendered in accordance with the adjusted moving trajectory. The adjusting manner may be various, which is not limited in the embodiment of the present disclosure.

In exemplary embodiments, the desktop background file may include a GIF file and a plurality of elements that represent weather. The GIF file shows dynamic image effects, and the plurality of elements are displayed in combination with the GIF file according to specifications such as their moving trajectories, so as to show effects specified by the desktop background file. Alternatively and/or additionally, the desktop background file includes a static desktop background picture and a plurality of elements that represent weather. The plurality of elements are rendered in accordance with their moving trajectories and display effects on the desktop background picture, so as to show effects specified by the desktop background file.

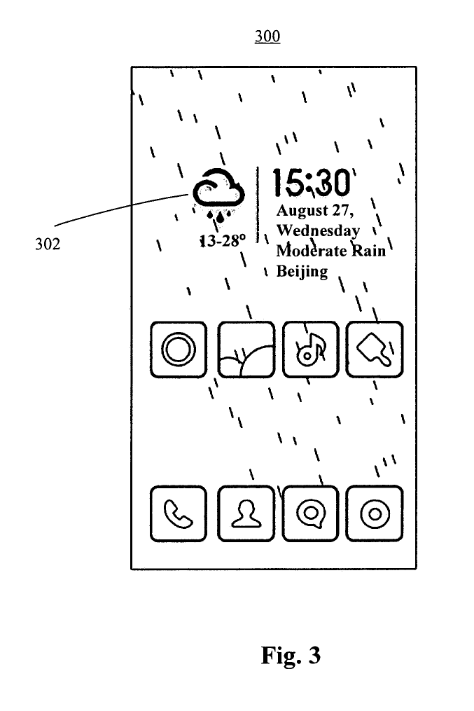

According to the resources and the moving trajectories and the display effects of the resources, dynamic effects may be generated. For example, FIG. 3 is a schematic diagram of a desktop 300 displayed on the terminal, according to an exemplary embodiment. Referring to FIG. 3, when the current weather is a rainy day, the resources corresponding to the rainy day may include a gray desktop background picture and a plurality of oblique lines which differ in lengths to identify the rainy day. The desktop background file also specifies the moving trajectories along which the oblique lines move downward and, thus, renders the desktop 300 with an effect that the raindrops continuously fall on the rainy day. The desktop background file may also include display effects of elements in a desktop plug-in. For example, in FIG. 3, text in a weather widget 302 may be rendered according to the display effects in the desktop background file, so that the text shows required effects.

In exemplary embodiments, the icon file of an icon includes an icon file corresponding to an inactive state and an icon file corresponding to an active file. Referring back to FIG. 2, in step 204, the icon file corresponding to the inactive state is rendered onto the desktop, when the corresponding icon is in an inactive state.

In exemplary embodiments, the icon file includes the icon file corresponding to the inactive state, the icon file corresponding to the active file, and an icon file corresponding to a preset operation. The icon file corresponding to the inactive state may be different from the icon file corresponding to the active file, that is, when the icon file is not activated, the icon file is rendered using the corresponding icon file, and when the icon file is activated, the icon file is rendered using an icon file having a different display effect, thereby representing influence of user operation on the icon file. The preset operation includes an operation of shaking, an operation of double-clicking a blank area on a screen, or an operation of blowing, but it is not limited thereto.

For example, the theme file may include a plurality of icon files corresponding to a plurality of icons. The terminal can acquire, according to an existing icon on the current desktop, an icon file corresponding to an inactive state corresponding to the existing icon, and render the icon file corresponding to the inactive state onto the desktop, such that the user may intuitively and quickly know current weather information.

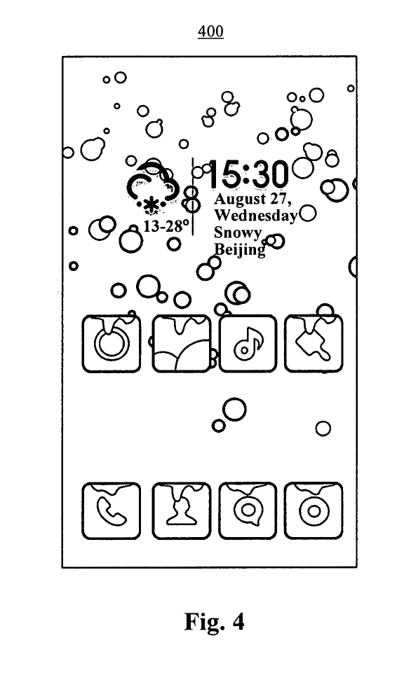

For example, FIG. 4 is a schematic diagram of a desktop 400 displayed on the terminal, according to an exemplary embodiment. Referring to FIG. 4, when the current weather is a snowy day, an effect of snowing is rendered on the desktop 400 in accordance with the desktop background file, and the terminal renders the icon file corresponding to the inactive state onto the desktop. Thus, an effect that snowflakes fall on icons of the desktop 400 is rendered, such that a user may intuitively and quickly know the current weather information.

Referring back to FIG. 2, in steps 203 and 204, the terminal performs rendering according to the theme file corresponding to the weather information. Steps 203 and 204 may be performed in parallel without a necessary sequence, which is not limited in the present embodiment.

In step 205, when an instruction to activate the inactive icon is detected, the terminal withdraws a rendering effect of the icon file corresponding to the inactive state, and renders the icon file corresponding to the active state onto the desktop. to start an application corresponding to the icon.

For example, when an instruction to activate an inactive icon is detected, the terminal withdraws a rendering effect of the icon file corresponding to the inactive state, and selects an icon file corresponding to an active state for the icon for which the instruction is detected. The terminal also renders the icon file corresponding to the active state onto the desktop, and starts an application corresponding to the icon for which the instruction is detected.

For example, in the above embodiment in which the snowflakes fall on icons (step 204), when an instruction to activate an icon is detected, the terminal withdraws the performed rendering according to the icon file corresponding to the inactive state, acquires the icon file corresponding to the active state for the icon from the theme file, and renders the icon file corresponding to the active state onto the desktop. For the snowy day, the icon file corresponding to the active state may be an initial display effect of the icon, thus an effect is shown that the snowflakes disappear due to the user's operation such as a click. The icon file corresponding to the active state may also provide a dynamic effect, for example, an effect that the snowflakes shake off and gradually disappear. After rendering, an application corresponding to the icon for which the instruction is detected is started. As a result, the user may feel to be personally on the scene of the snowy day when operating on the application.

In step 206, when a preset operation is detected, the terminal withdraws the rendering effect of the icon file corresponding to the inactive state, and renders the icon file corresponding to the present operation onto the desktop.

For example, when the operation of shaking, the operation of double-clicking a blank area on a screen, or the operation of blowing of the terminal is detected, the terminal withdraws the rendering effect of the icon file corresponding to the inactive state, and renders the icon file corresponding to the preset operation onto the desktop.

The icon file corresponding to the preset operation may have effects similar to effects showed by the icon file corresponding to the active state, and the preset operation may be a preset operation for a plurality of icons. For example, if current weather is the snowy day, a plurality of icons on the desktop are displayed to have snowflakes. When the operation of shaking of the terminal is detected, the terminal withdraws the rendering effect on the desktop by the icon file corresponding to the inactive state, and the icon file corresponding to the preset operation is rendered on the desktop, thus showing the effect that the snowflakes on the icons of the desktop disappear.

Further, the theme file may also include a desktop background file corresponding to the preset operation. Accordingly, when the preset operation is detected, not only icons are re-rendered, but also the desktop background is re-rendered. For example, for the effect that the snowflakes fall on icons, when the operation of shaking of the terminal is detected, the terminal withdraws the rendering effects of the icon files in the inactive state onto the desktop, and renders the icon file corresponding to the preset operation onto the desktop, thus rendering the effect that the snowflakes on the icons of the desktop shake off and gradually disappear. Further, the terminal renders an effect in the desktop background that the snowflakes fall, or fly up, from the icons.

By using the method 200, the desktop background and the display effect of an icon on the desktop may correspond to current weather information. Accordingly, the user may intuitively and quickly know the current weather information without viewing detailed text information.

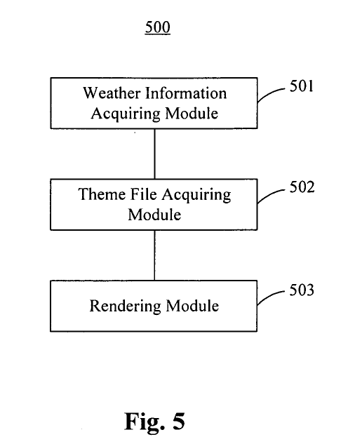

FIG. 5 is a block diagram of a device 500 for displaying a desktop, according to an exemplary embodiment. Referring to FIG. 5, the device 500 includes a weather information acquiring module 501, a theme file acquiring module 502, and a rendering module 503.

The weather information acquiring module 501 is configured to acquire current weather information, and is connected with the theme file acquiring module 502. The theme file acquiring module 502 is configured to acquire a theme file corresponding to the current weather information from a pre-downloaded theme package according to the acquired current weather information, the theme file including at least a desktop background file and an icon file. The theme file acquiring module 502 is connected with the rendering module 503. The rendering module 503 is configured to render the desktop background file and the icon file onto a desktop.

In one exemplary embodiment, the weather information acquiring module 501 includes at least one of a first weather information acquisition unit configured to acquire, according to a geographical location preset by the terminal, weather information corresponding to the geographical location, or a second weather information acquisition unit configured to acquire, according to a geographical location where the terminal is currently located, weather information corresponding to the geographical location.

In one exemplary embodiment, the desktop background file includes a plurality of resources and moving trajectories and display resources of the resources. The rendering module 503 is configured to render the desktop of the device 500 in accordance with the plurality of resources and the moving trajectories and the display resources of the resources, such that the resources present the display effects and move according to the moving trajectories on the desktop.

In one exemplary embodiment, the icon file includes an icon file corresponding to an inactive state and an icon file corresponding to an active state. The rendering module 503 includes at least one of an inactive state rendering unit configured to render the icon file corresponding to the inactive state onto the desktop, when the corresponding icon is in an inactive state, or an active state rendering unit configured to, when an instruction to activate an inactive icon is detected, withdraw a rendering effect of the icon file corresponding to the inactive state and render the icon file corresponding to the active state onto the desktop, to start an application corresponding to the icon.

In one exemplary embodiment, the icon file further includes an icon file corresponding to a preset operation. The rendering module 503 is configured to, when the preset operation is detected, withdraw the rendering effect of the icon file corresponding to the inactive state, and render the icon file corresponding to the preset operation onto the desktop.

For example, the preset operation can be an operation of shaking, an operation of double-clicking a blank area on a screen, or an operation of blowing.

By acquiring a theme file corresponding to the current weather information, and rendering the acquired theme file onto the desktop, the device 500 can display a desktop background and a display effect of an icon on the desktop that correspond to the current weather information. Accordingly, a user of the device 500 may intuitively and quickly know the current weather information without viewing detailed text information.

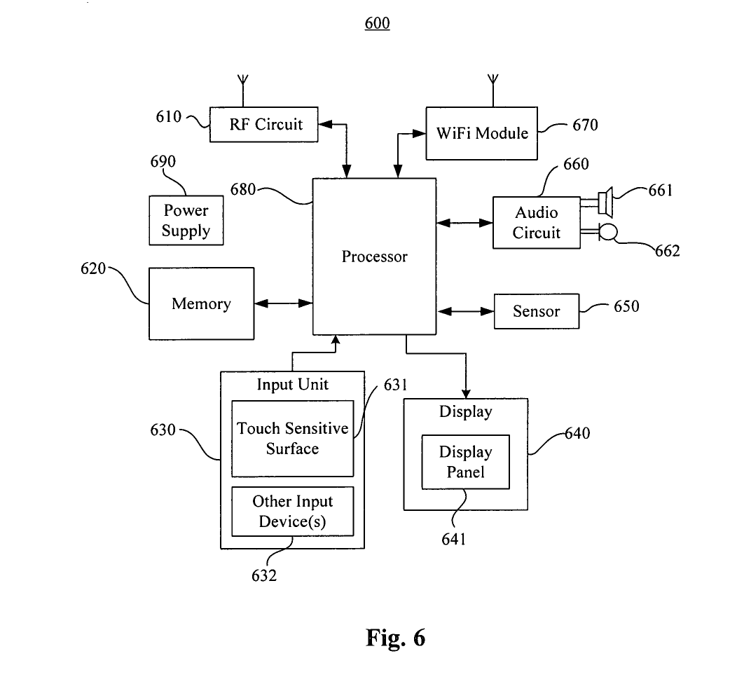

FIG. 6 is a block diagram of a terminal 600, according to an exemplary embodiment. The terminal 600 is configured to implement the above described methods for displaying a desktop.

Referring to FIG. 6, the terminal 600 may include one or more of a radio frequency (RF) circuit 610, memory resources represented by a memory 620, an input unit 630, a display 640, a sensor 650, an audio circuit 660, a wireless fidelity (WiFi) module 670, a processor 680 including one or more processing cores, and a power supply 190 and the like. Those skilled in the art will understand that the structure shown in FIG. 6 is not restrictive to the terminal 600, and the terminal 600 may comprise more or less components than those in FIG. 6, or a combination of some components, or have different component arrangements.

The RF circuit 610 is configured to send and receive signals during sending and receiving information or a process of calling. For example, the RF circuit 610 receives downlink information from a base station and then transmits the downlink information to the processor 680 to be processed, and transmits related uplink data to the base station. Generally, the RF circuit 610 includes, but is not limited to, an antenna, at least one amplifier, a tuner, one or more oscillators, a Subscriber Identity Module (SIM) card, a transceiver, a coupler, a low noise amplifier (LNA), a duplexer and the like. Additionally, the RF circuit 610 may also communicate with a network or other devices via wireless communication. The wireless communication may adopt any one of communication standard or protocol including, but not limited to, global system of mobile communication (GSM), general packet radio service (GPRS), code division multiple access (CDMA), wideband code division multiple access (WCDMA), long term evolution (LTE), email, short messaging service (SMS), and the like.

The memory 620 is configured to store software programs and modules, which allow various types of functional applications and data processes to be performed when executed by the processor 680. The memory 620 may mainly include a program storage area and a data storage area. The program storage area may store an operating system, applications required by at least one function (such as voice play function, an image play function and the like). The data storage area may store data (such as video data, phonebook data, and the like) created by the terminal 600. In addition, the memory 620 may include a high speed random access memory. The memory 620 may also include a nonvolatile memory (NVM), such as at least a magnetic disk storage device, a flash memory or other nonvolatile solid-state storage devices. Correspondingly, the memory 620 may also include a memory controller to control access to the memory 620 performed by the processor 680 and the input unit 630.

The input unit 630 is configured to receive input numerical or character information and generate signal inputs through a keypad, a mouse, a joystick, an optical device, or trackball related to user settings and function control. For example, the input unit 630 may include a touch sensitive surface 631 and one or more other input device(s) 632. The touch sensitive surface 631, also called a touch display screen or a track pad, may collect a touch operation on or near it by the user (for example the user operations on or near the touch sensitive surface 631 with any kind of suitable objects or attachments such as a finger, a touch pen, and the like), and drive the corresponding connected device according to a preset program. The touch sensitive surface 631 may include first and second parts, i.e., a touch detecting device and a touch controller. The touch detecting device may detect a touch orientation of the user, detect a signal caused by the touch operation, and then transmit the signal to the touch controller. The touch controller may receive the touch information from the touch detecting device and convert it into touch point coordinates and then transmit the coordinates to the processor 680, and may receive a command sent from the processor 680 to execute it. Additionally, the touch sensitive surface 631 may be realized in various types, such as a resistive type, a capacitive type, an infrared type, or a surface acoustic wave type and the like. The input unit 630 may also include one or more other input devices 632. For example, the other input devices 632 may include, without limitation, one or more of a physical keypad, functional buttons (such as a volume control button, a switch button and the like), a trackball, a mouse, a joystick and the like.

The display 640 is configured to display various graphic user interfaces and information input by the user or provided to the user. These graphic user interfaces may be made up of graphics, texts, icons, videos and any combination thereof. The display 640 may include a display panel 641 configured with a liquid crystal display (LCD), an organic light-emitting diode (OLED), and the like. Furthermore, the touch sensitive surface 631 may be configured to cover the display panel 641. When detecting a touch operation performed on or near the touch sensitive surface 631, the touch sensitive surface 631 may transmit signals to the processor 680 to determine the type of the touch operation, and then the processor 680 may provide a corresponding visual output on the display panel 641 according to the type of the touch operation. Although in FIG. 6 the touch sensitive surface 631 and the display panel 641 realize input and output functions as two independent components, they may be integrated together in some embodiments to realize input and output functions.

The sensor 650 may be a photo sensor, a motion sensor, or any other sensors. For example, the photo sensor may include an ambient light sensor and a proximity sensor. The ambient light sensor may adjust brightness of the display panel 641 according to intensity of the ambient light. The proximity sensor may close the display panel 641 and/or backlight when the terminal 600 is close to the user's ear. As an example of the motion sensor, a gravitational acceleration sensor may detect values of accelerations in various directions (e.g., along three axes), and may detect a value and a direction of the gravitation when in a stationary state. The gravity acceleration sensor may be used in an application for identifying an attitude of the terminal 600 (such as switching between a landscape mode and a vertical mode, corresponding games, magnetometer pose adjusting), functions related to vibration (such as a pedometer, knocking), and the like. Other sensors which may be arranged in the terminal 600 include a gyroscope, a barometer, a hygrometer, a thermometer, an infrared sensor and the like.

The audio circuit 660 is coupled to a speaker 661 and a microphone 662, and may provide an audio interface between the user and the terminal 600. The audio circuit 660 may convert received audio data into electronic signals and transmit the electronic signals to the speaker 661, and the speaker 661 may convert the electronic signals into voice and output the voice. Additionally, the microphone 662 may convert collected voice signals into electronic signals, and the audio circuit 660 receives the electronic signals and converts them into audio data. The audio data is transmitted to the processor 680 and then is transmitted to another terminal via the RF circuit 610 after processed by the processor 680, or the audio data is transmitted to the memory 620 to be further processed. The audio circuit 660 may also include an earplug jack to allow communication between a peripheral earphone and the terminal 600.

The WiFi module 670 provides the user with wireless broadband internet access, which allows the user to transmit or receive E-mails, browse web pages, and access streaming media and the like. Although the WiFi module 670 is shown in FIG. 6, it should be understood that the WiFi module 670 is not a necessary component of the terminal 600, and may be omitted according to requirements.

The processor 680 is a control center of the terminal 600 that use various interfaces and wires to connect respective portions of the whole terminal. By running or executing software programs and/or modules stored in the memory 620, calling data stored in the memory 620, and executing various functions of the terminal 600 and processing data, the processor 680 handles overall monitoring of the terminal 600. The processor 680 may include one or more processing cores, and may integrate an application processor and a modem processor. The application processor may mainly process the operation system, user interfaces, application programs and the like, and the modem processor may mainly process wireless communications. In some embodiments, the modem processor may not be integrated into the processor 680.

The power supply 690 is configured to supply power to respective components of the terminal 600. The power supply may be logically connected with the processor 680 through a power supply management system, thereby realizing functions of managing charging, discharging, and power consumption, through the power supply management system. The power supply 690 may further include one or more of a direct current (DC) power supply or an alternating current (AC) power supply, a rechargeable system, a power supply malfunction detection circuit, a power supply converter or an inverter, a power supply state indicator and the like.

Although not shown, the terminal 600 may also include a camera, a Bluetooth module, etc.

In exemplary embodiments, there is also provided a non-transitory readable storage medium including instructions, such as included in the memory 620, executable by the processor 680 in the terminal 600, for performing the above-described methods for displaying a desktop.

One of ordinary skill in the art will understand that the above described modules/units can each be implemented by hardware, or software, or a combination of hardware and software. One of ordinary skill in the art will also understand that multiple ones of the above described modules/units may be combined as one module/unit, and each of the above described modules/units may be further divided into a plurality of sub-modules/sub-units.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for displaying a desktop on a device, comprising:
acquiring current weather information;
acquiring, according to the acquired current weather information, a theme file corresponding to the current weather information from a pre-downloaded theme package, the theme file including at least a desktop background file, and an icon file corresponding to an icon; and
rendering the desktop background file and the icon file onto the desktop of the device.

2. The method according to claim 1, wherein the acquiring of the current weather information comprises:
acquiring, according to a preset geographical location, weather information corresponding to the geographical location.

3. The method according to claim 1, wherein the acquiring of the current weather information comprises:
acquiring, according to a geographical location where the terminal is currently located, weather information corresponding to the geographical location.

4. The method according to claim 1, wherein the desktop background file includes a plurality of resources and moving trajectories and display effects of the resources, and the rendering of the desktop background file and the icon file onto the desktop of the device comprises:
rendering the desktop in accordance with the plurality of resources and the moving trajectories and the display effects of the resources, such that the resources present the display effects and move according to the moving trajectories on the desktop.

5. The method according to claim 4, wherein the icon file includes a first icon file corresponding to an inactive state and a second icon file corresponding to an active state, and the rendering of the desktop background file and the icon file onto the desktop comprises:
when the icon corresponding to the icon file is in an inactive state, rendering the first icon file corresponding to the inactive state onto the desktop; and
when an instruction to activate the icon in the inactive state is detected, withdrawing a rendering effect of the first icon file corresponding to the inactive state;
rendering the second icon file corresponding to the active state onto the desktop; and
starting an application corresponding to the icon.

6. The method according to claim 5, wherein the icon file further includes a third icon file corresponding to a preset operation, and the rendering of the desktop background file and the icon file onto the desktop comprises:
when the preset operation is detected, withdrawing the rendering effect of the first icon file corresponding to the inactive state, and rendering the third icon file corresponding to the preset operation onto the desktop.

7. The method according to claim 6, wherein detecting the preset operation comprises:
detecting one of an operation of shaking, an operation of double-clicking a blank area on a screen, or an operation of blowing.

8. A terminal, comprising:
a processor; and
a memory for storing instructions executable by the processor;
wherein the processor is configured to:
acquire current weather information;
acquire, according to the acquired current weather information, a theme file corresponding to the current weather information from a pre-downloaded theme package, the theme file including at least a desktop background file, and an icon file corresponding to an icon; and
render the desktop background file and the icon file onto the desktop of the device.

9. The terminal according to claim 8, wherein the processor is further configured to:
acquire, according to a geographical location preset by the terminal, weather information corresponding to the geographical location.

10. The terminal according to claim 8, wherein the processor is further configured to:
acquire, according to a geographical location where the terminal is currently located, weather information corresponding to the geographical location.

11. The terminal according to claim 8, wherein the desktop background file includes a plurality of resources and moving trajectories and display effects of the resources, and the processor is further configured to:
render the desktop in accordance with the plurality of resources and the moving trajectories and the display effects of the resources, such that the resources present the display effects and move according to the moving trajectories on the desktop.

12. The terminal according to claim 11, wherein the icon file includes a first icon file corresponding to an inactive state and a second icon file corresponding to an active state, and the processor is further configured to:
when the icon corresponding to the icon file is in an inactive state, render the first icon file corresponding to the inactive state onto the desktop; and
when an instruction to activate the icon in the inactive state is detected,
withdraw a rendering effect of the first icon file corresponding to the inactive state;
render the second icon file corresponding to the active state onto the desktop; and
start an application corresponding to the icon.

13. The terminal according to claim 12, wherein the icon file further includes a third icon file corresponding to a preset operation, and the processor is further configured to:
when the preset operation is detected, withdraw the rendering effect of the first icon file corresponding to the inactive state, and render the third icon file corresponding to the preset operation onto the desktop.

14. The terminal according to claim 13, wherein the processor is further configured to:
detect one of an operation of shaking, an operation of double-clicking a blank area on a screen, or an operation of blowing to detect the preset operation.

15. A non-transitory storage medium having stored therein instructions that, when executed by a processor of a terminal, cause the terminal to perform a method for displaying a desktop, the method comprising:
acquiring current weather information;
acquiring, according to the acquired current weather information, a theme file corresponding to the current weather information from a pre-downloaded theme package, the theme file including at least a desktop background file, and an icon file corresponding to an icon; and
rendering the desktop background file and the icon file onto the desktop of the device.
